(19) United States
(12) Patent Application Publication
(10) Pub. No.: US 2026/0056586 A1
(43) Pub. Date: Feb. 26, 2026

(54) SYSTEMS AND METHODS FOR MAINTAINING BATTERY HEALTH

(71) Applicant: Dell Products L.P., Round Rock, TX (US)

(72) Inventors: Shao-Szu HO, New Taipei City (TW); Chia-Kun WU, Taoyuan City (TW)

(73) Assignee: Dell Products L.P., Round Rock, TX (US)

(21) Appl. No.: 18/810,096

(22) Filed: Aug. 20, 2024

(51) Int. Cl. G06F 1/20; G06F 1/26; G06F 1/28

(52) U.S. Cl. CPC G06F 1/206; G06F 1/203; G06F 1/263; G06F 1/28

(57) ABSTRACT

An information handling system may include a processor, a power supply unit for supplying electrical energy to information handling resources of the information handling system, a battery backup unit for supplying electrical energy to the information handling resources responsive to a power event associated with the power supply unit, a thermal control system for controlling a temperature associated with the information handling system, and a battery management agent configured to determine battery aging parameters for a battery of the battery backup unit as a function of temperature and based on the battery aging parameters, usage history, and temperature history for the battery, control the temperature.

### TECHNICAL FIELD

The present disclosure relates in general to information handling systems, and more particularly to systems and methods for maintaining battery health, for example in a battery backup unit, in an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may include one or more power supply units for providing electrical energy to components of the information handling system. Typically, a power supply unit is configured to operate from an input alternating current (AC) source of electrical energy, which the power supply unit converts to a direct current (DC) output. Thus, typically a power supply unit may include a rectifier and/or power factor correction stage to receive the input AC source and rectify the input AC waveform to charge a bulk capacitor to a desired voltage. A direct-current-to-direct-current (DC-DC) stage may convert the voltage on the bulk capacitor to a DC output voltage which may be used to power components of the information handling system.

Some information handling systems also utilize one or more battery backup units. A battery backup unit may be configured to, in response to a power event (e.g., an alternating current source loss to a power supply unit or other fault or failure of such a power supply unit), supply energy stored in a battery or other energy storage device (e.g., a capacitor) to components of the information handling system. Accordingly, in information handling systems equipped with battery backup units, power may be retained for a small amount of time after the power event.

Many factors may affect the health of a battery in a battery backup unit, such as voltage level, ambient temperature, usage time, and number of charging cycles. Among these factors, temperature may be the most important factor. Because of the chemical characteristics of a battery cell, aging of the cell may be aggravated at high temperatures, especially when the battery cell is fully charged.

### SUMMARY

In accordance with the teachings of the present disclosure, the disadvantages and problems associated with maintaining battery health may be reduced or eliminated.

In accordance with embodiments of the present disclosure, an information handling system may include a processor, a power supply unit for supplying electrical energy to information handling resources of the information handling system, a battery backup unit for supplying electrical energy to the information handling resources responsive to a power event associated with the power supply unit, a thermal control system for controlling a temperature associated with the information handling system, and a battery management agent configured to determine battery aging parameters for a battery of the battery backup unit as a function of temperature and based on the battery aging parameters, usage history, and temperature history for the battery, control the temperature.

In accordance with these and other embodiments of the present disclosure, a method may include determining battery aging parameters for a battery of a battery backup unit as a function of temperature and based on the battery aging parameters, usage history, and temperature history for the battery, controlling a temperature associated with an information handling system comprising the battery.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to determine battery aging parameters for a battery of a battery backup unit as a function of temperature and based on the battery aging parameters, usage history, and temperature history for the battery, control a temperature associated with an information handling system comprising the battery.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 is a graph that illustrates full charge capacities for a battery of a battery backup unit at different temperatures, in accordance with embodiments of the present disclosure;

FIG. 3 is a graph that illustrates an example battery life curve of a battery of a battery backup unit at different temperatures over various periods of time, in accordance with embodiments of the present disclosure; and

FIG. 4 illustrates a flow chart of an example method for maintaining battery health, in accordance with embodiments of the present disclosure.

### DETAILED DESCRIPTION

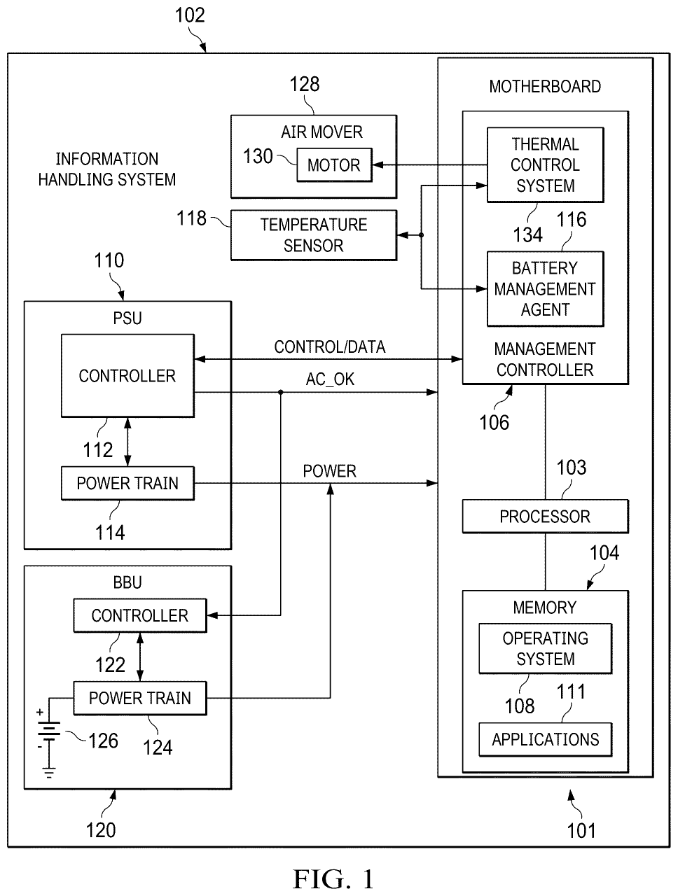

Preferred embodiments and their advantages are best understood by reference to FIGS. 1 through 4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal data assistant (PDA), a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, power supplies, air movers (e.g., fans and blowers) and/or any other components and/or elements of an information handling system.

FIG. 1 illustrates a block diagram of an example of an information handling system 102. As depicted, information handling system 102 may include a power supply unit (PSU) 110, a motherboard 101, a temperature sensor 118, a battery backup unit (BBU) 120, an air mover 128, and one or more other information handling resources.

Motherboard 101 may include a circuit board configured to provide structural support for one or more information handling resources of information handling system 102 and/or electrically couple one or more of such information handling resources to each other and/or to other electric or electronic components external to information handling system 102. As shown in FIG. 1, motherboard 101 may include a processor 103, memory 104, a management controller 106, and one or more other information handling resources.

Processor 103 may comprise any system, device, or apparatus operable to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may comprise any system, device, or apparatus operable to retain program instructions or data for a period of time. Memory 104 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 102 is turned off. In particular embodiments, memory 104 may comprise a non-volatile memory comprising one or more NVDIMMs.

As shown in FIG. 1, memory 104 may have stored thereon an operating system (OS) 108 and one or more applications 111.

OS 108 may comprise any program of executable instructions, or aggregation of programs of executable instructions, configured to manage and/or control the allocation and usage of hardware resources such as memory, CPU time, disk space, and input and output devices, and provide an interface between such hardware resources and application programs hosted by OS 108. Although FIG. 1 depicts OS 108 as being stored in memory 104, in some embodiments, active portions of OS 108 may be transferred to memory 104 from a computer-readable medium (e.g., a hard disk drive) for execution by processor 103.

An application 111 may comprise any program of executable instructions, or aggregation of programs of executable instructions, configured to, when read and executed by processor 103, interact with operating system 108 in order to perform a group of coordinated functions, tasks, or activities.

Management controller 106 may be configured to provide out-of-band management facilities for management of information handling system 102. Such management may be made by management controller 106 even if information handling system 102 is powered off or powered to a standby state. Management controller 106 may include a processor, memory, an out-of-band network interface separate from and physically isolated from an in-band network interface of information handling system 102, and/or other embedded information handling resources. In certain embodiments, management controller 106 may include or may be an integral part of a baseboard management controller (BMC) or a remote access controller (e.g., a Dell Remote Access Controller or Integrated Dell Remote Access Controller). In other embodiments, management controller 106 may include or may be an integral part of a chassis management controller (CMC). In some embodiments, management controller 106 may be configured to communicate with a PSU 110 to communicate control and/or telemetry data between management controller 106 and PSU 110 (e.g., via a Power Management Bus). For example, PSU 110 may communicate information regarding status and/or health of PSU 110 and/or measurements of electrical parameters (e.g., electrical currents or voltages) present within PSU 110. As shown in FIG. 1, management controller 106 may comprise a battery management agent 116 and a thermal control system 134.

Battery management agent 116 may comprise any program of instructions embodied in software, hardware, or firmware of management controller 106 and configured to, when read and executed by a processor of management controller 106, manage battery health of BBU 120, as described in greater detail below.

Thermal control system 134 may include any system, device, or apparatus configured to receive one or more signals indicative of one or more temperatures within information handling system 102 (e.g., one or more signals from one or more temperature sensors 118), and based on such signals, calculate an air mover driving signal (e.g., a pulse-width modulation signal) to maintain an appropriate level of cooling, increase cooling, or decrease cooling, as appropriate, and communicate such air mover driving signal to air mover 128. In some embodiments, thermal control system 134 may control cooling of information handling system 102 in accordance with an ambient temperature setting determined by battery management agent 116, as described in greater detail below. In some embodiments, thermal control system 134 may include a program of instructions (e.g., software, firmware) configured to, when executed by a processor or controller integral to management controller 106, carry out the functionality of thermal control system 134.

Temperature sensor 118 may be any system, device, or apparatus (e.g., a thermometer, thermistor, etc.) configured to communicate a signal to thermal control system 134, battery management agent 116, and/or other components of information handling system 102 indicative of a temperature within information handling system 102. In some embodiments, a plurality of temperature sensors 118 may be spread throughout different locations in information handling system 102.

Generally speaking, PSU 110 may include any system, device, or apparatus configured to supply electrical current to one or more information handling resources of information handling system 102. As shown in FIG. 1, PSU 110 may include a controller 112 and a power train 114. Power train 114 of PSU 110 may be coupled at its outputs to a power bus configured to deliver electrical energy to motherboard 101 and other components of information handling system 102.

Controller 112 may comprise a microprocessor, DSP, ASIC, FPGA, EEPROM, or any combination thereof, or any other device, system, or apparatus for controlling operation of PSU 110. As such, controller 112 may comprise firmware, logic, and/or data for controlling functionality of PSU 110. As shown in FIG. 1, controller 112 may be communicatively coupled to management controller 106 allowing for communication of data and/or control signals between management controller 106 and controller 112.

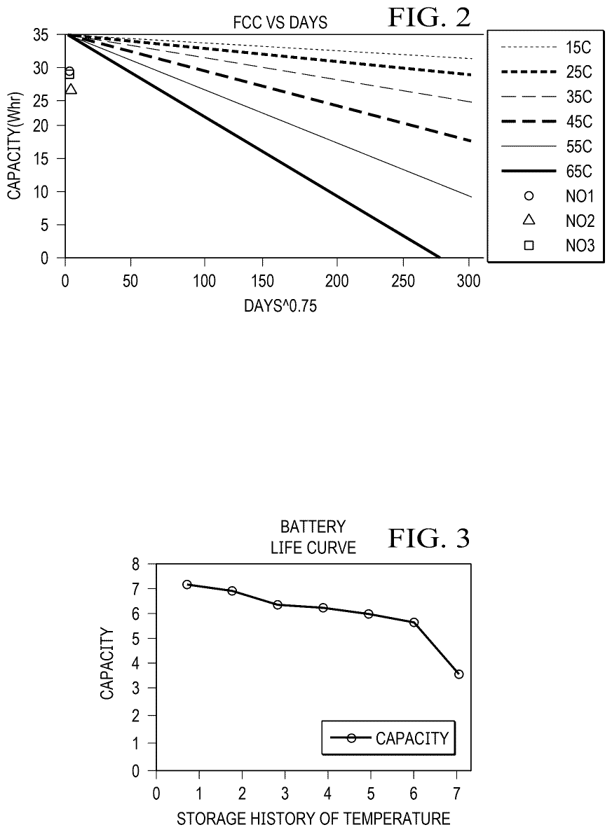

Power train 114 may include any suitable system, device, or apparatus for converting electrical energy received by PSU 110 (e.g., a 120-volt alternating current voltage waveform) into electrical energy usable to information handling resources of information handling system 102 (e.g., 12-volt direct current voltage source). In some embodiments, power train 114 may comprise a rectifier. In these and other embodiments, power train 114 may comprise a voltage regulator (e.g., a multi-phase voltage regulator). An example implementation of power train 114 is set forth in FIG. 2 below.

Generally speaking, BBU 120 may include any system, device, or apparatus configured to supply electrical current to one or more information handling resources of information handling system 102. In some embodiments, BBU 120 may be configured to supply electrical current responsive to a power event. In some embodiments, in the event of a power event associated with PSU 110 (e.g., failure, loss of an input power source to PSU 110, etc.), PSU 110 may de-assert a signal (labeled AC OK in FIG. 1, indicating loss by such PSU 110 of its alternating current input sources) and communicate such signal to BBU 120, causing BBU 120 to activate from a deactivated state to supply electrical current to a power bus of information handling system 102. As shown in FIG. 1, BBU 120 may include a controller 122 and a power train 124.

Controller 122 may comprise a microprocessor, DSP, ASIC, FPGA, EEPROM, or any combination thereof, or any other device, system, or apparatus for controlling operation of BBU 120. As such, controller 122 may comprise firmware, logic, and/or data for controlling functionality of BBU 120.

Power train 124 may include any suitable system, device, or apparatus for converting electrical energy received by BBU 120 from a battery 126 or other energy storage device (e.g., a capacitor) into electrical energy usable to information handling resources of information handling system 102 (e.g., 12-volt direct current voltage source). Accordingly, in some embodiments, power train 124 may comprise a direct-current-to-direct-current converter (e.g., a boost converter or buck converter). In operation, power train 124 may deliver an amount of electrical current to a power bus of information handling system 102 in accordance with a control signal communicated from controller 122 indicative of a desired amount of electrical current to be delivered.

Air mover 128 may include any mechanical or electro-mechanical system, apparatus, or device operable to move air and/or other gases in order to cool information handling resources of information handling system 102. In some embodiments, air mover 128 may comprise a fan (e.g., a rotating arrangement of vanes or blades which act on the air). In other embodiments, air mover 128 may comprise a blower (e.g., a centrifugal fan that employs rotating impellers to accelerate air received at its intake and which may change the direction of the airflow). In these and other embodiments, rotating and other moving components of air mover 108 may be driven by a motor 130. The rotational speed of motor 130 may be controlled by an air mover control signal (e.g., a pulse-width modulation signal) communicated from thermal control system 134 of management controller 106. In operation, air mover 128 may cool information handling resources of information handling system 102 by drawing cool air into an enclosure housing the information handling resources from outside the chassis, expelling warm air from inside the enclosure to the outside of such enclosure, and/or moving air across one or more heat sinks (not explicitly shown) internal to the enclosure to cool one or more information handling resources.

In addition to motherboard 101, processor 103, memory 104, management controller 106, PSU 110, temperature sensor 118, BBU 120, and air mover 128, information handling system 102 may include one or more other information handling resources. For example, in some embodiments, information handling system 102 may include more than one PSU 110, more than one BBU 120, and/or more than one temperature sensor 118.

In operation, battery management agent 116 may perform monitoring of battery health of battery 126 of BBU 120 and may further cause thermal control system 134 to adjust an ambient temperature within information handling system 102 in order to maintain battery health (e.g., by minimizing temperature-induced aging of battery 126).

To illustrate, reference is made to FIG. 2, which depicts full charge capacities for battery 126 at different temperatures, in accordance with embodiments of the present disclosure. Battery charge storage under fully-charged conditions may have the greatest impact on chemical materials as compared to other factors, and battery aging under a fully-charged condition may have a greater impact than the aging factor of charge cycling. By using information regarding the full charge capacity at various temperatures, battery management agent 116 may generate age projections for battery 126 at different temperatures.

To further illustrate, Table 1 below depicts cell aging factors at different ambient temperatures, and expected battery capacities after 0, 100, 200, and 300 days assuming battery 126 remains at such ambient temperatures. Table 2 below depicts an example of capacity over time for battery 126 as its experiences various ambient temperatures over different periods of time. From the information in Table 2, a battery life curve may be generated, such as that shown in FIG. 3.

Based on the age factors at various temperatures, battery management agent 116 may predict a future capacity for BBU 120 should the ambient temperature for BBU 120 remain unchanged. Further, should such future capacity be below a particular threshold, battery management agent 116 may cause thermal control system 134 to reduce the ambient temperature in an attempt to increase the future capacity above such threshold.

TABLE 1

| Days | FCC (15°) | FCC (25°) | FCC (35°) | FCC (45°) | FCC (55°) | FCC ( 65°) |
|---|---|---|---|---|---|---|
| Age | −0.00279 | −0.00459 | −0.00752 | −0.01178 | −0.01796 | −0.02671 |
| Factor | | | | | | |
| 0 | 7.4 | 7.4 | 7.4 | 7.4 | 7.4 | 7.4 |
| 100 | 7.121 | 6.941 | 6.648 | 6.222 | 5.604 | 4.729 |
| 200 | 6.842 | 6.482 | 5.896 | 5.044 | 3.808 | 2.058 |
| 300 | 6.563 | 6.023 | 5.144 | 3.866 | 2.012 | −0.613 |

TABLE 2

| | | | | | | |
|---|---|---|---|---|---|---|
| Initial | 7.4 | | | | | |
| capacity | | | | | | |
| Temp | 25° | 35° | 55° | 25° | 45° | 35° |
| hrs | 100 | 200 | 300 | 400 | 500 | 700 |
| capacity | 7.259 | 7.028 | 6.477 | 6.336 | 6.105 | 5.729 |

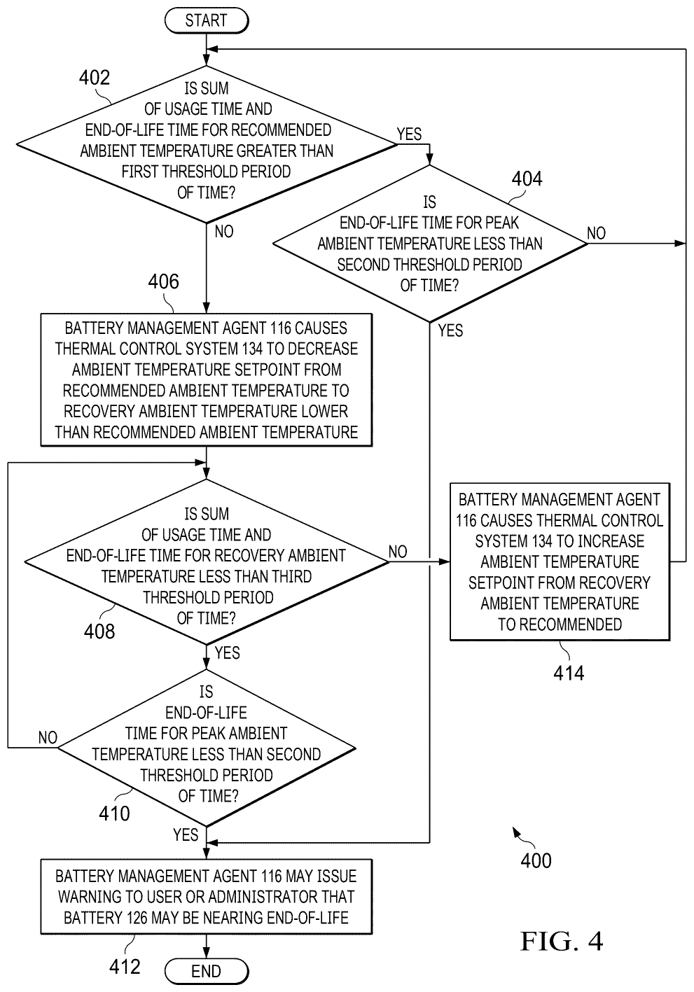

FIG. 4 illustrates a flow chart of an example method 400 for maintaining battery health, in accordance with embodiments of the present disclosure. According to some embodiments, method 400 may begin at step 402. As noted above, teachings of the present disclosure may be implemented in a variety of configurations of information handling system 102. As such, the preferred initialization point for method 400 and the order of the steps comprising method 400 may depend on the implementation chosen.

At step 402, based on an estimated end-of-life time at each of a plurality of ambient temperatures and a usage time (i.e., the amount of time that battery 126 has been in use) for battery 126, battery management agent 116 may compare the sum of the usage time and an end-of-life time for a recommended ambient temperature (e.g., 50° C.) to a first threshold period of time (e.g., five years). If the sum of the usage time and an end-of-life time for the recommended ambient temperature is greater than the first threshold period of time, method 400 may proceed to step 404. Otherwise, method 400 may proceed to step 406.

At step 404, battery management agent 116 may compare an end-of-life time for a peak ambient temperature (e.g., 55° C.) higher than the recommended temperature to a second threshold period of time (e.g., three months). Such peak ambient temperature may represent a maximum ambient temperature that may be expected. If the end-of-life time for the peak ambient temperature is less than the second threshold period of time, method 400 may proceed to step 412. Otherwise 400 method may proceed again to step 402.

At step 406, in order to minimize aging, battery management agent 116 may cause thermal control system 134 to decrease the ambient temperature setpoint from the recommended ambient temperature to a recovery ambient temperature lower than the recommended ambient temperature (e.g., 45° C.).

At step 408, battery management agent 116 may compare the sum of the usage time and an end-of-life time for the recovery ambient temperature to a third threshold period of time (e.g., five years). The third threshold period of time may be the same or different than the first threshold period of time. If the sum of the usage time and an end-of-life time for the recovery ambient temperature is less than the third threshold period of time, method 400 may proceed to step 410. Otherwise method 400 may proceed to step 414.

At step 410, battery management agent 116 may compare an end-of-life time for the peak ambient temperature to the second threshold period of time. If the end-of-life time for the peak ambient temperature is less than the second threshold period of time, method 400 may proceed to step 412. Otherwise method 400 may proceed again to step 408.

At step 412, battery management agent 116 may issue a warning to a user or administrator of information handling system 102 warning the user that battery 126 may be nearing its end-of-life. In addition or alternatively, battery management agent 116 may take other remedial actions, including further reducing ambient temperature. After execution of step 412, method 400 may end.

At step 414, battery management agent 116 may cause thermal control system 134 to increase the ambient temperature setpoint from the recovery ambient temperature to the recommended ambient temperature. After completion of step 414, method 400 may proceed again to step 402.

Although FIG. 4 discloses a particular number of steps to be taken with respect to method 400, method 400 may be executed with greater or fewer steps than those depicted in FIG. 4. In addition, although FIG. 4 discloses a certain order of steps to be taken with respect to method 400, the steps comprising method 400 may be completed in any suitable order.

Method 400 may be implemented using information handling system 102 or any other system operable to implement method 400. In certain embodiments, method 400 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. An information handling system comprising:
a processor;
a power supply unit for supplying electrical energy to information handling resources of the information handling system;
a battery backup unit for supplying electrical energy to the information handling resources responsive to a power event associated with the power supply unit;
a thermal control system for controlling a temperature associated with the information handling system; and
a battery management agent configured to:
determine battery aging parameters for a battery of the battery backup unit as a function of temperature; and
based on the battery aging parameters, usage history, and temperature history for the battery, control the temperature.

2. A method comprising:
determining battery aging parameters for a battery of a battery backup unit as a function of temperature; and
based on the battery aging parameters, usage history, and temperature history for the battery, controlling a temperature associated with an information handling system comprising the battery.

3. An article of manufacture comprising:
a non-transitory computer-readable medium; and
computer-executable instructions carried on the computer-readable medium, the instructions readable by a processor, the instructions, when read and executed, for causing the processor to:
determine battery aging parameters for a battery of a battery backup unit as a function of temperature; and
based on the battery aging parameters, usage history, and temperature history for the battery, control a temperature associated with an information handling system comprising the battery.
